(19) United States
(12) Patent Application Publication
(10) Pub. No.: US 2013/0290031 A1
(43) Pub. Date: Oct. 31, 2013

(54) Teleradiology System

(71) Applicant: Knight Radiology LLC, Concord, MA (US)

(72) Inventors: Susannah Kay, Concord, MA (US); Joshua Kablotsky, Carlisle, MA (US)

(21) Appl. No.: 13/931,258

(22) Filed: Jun. 28, 2013

Related U.S. Application Data
(63) Continuation of application No. PCT/US2011/051282, filed on Sep. 13, 2011.
Application No. PCT/US2011/051282 is a division of application No. 13/748,317, filed on Jan. 23, 2013.

(51) Int. Cl. G06F 19/00

(52) U.S. Cl. CPC G06F 19/321
USPC 705/3

(57) ABSTRACT

Prior studies associated with a patient are pre-fetched from multiple institutions and made available to a radiologist while the radiologist is viewing a series. Intelligent report generation is template driven with templates based on modality, body part, and radiologist. The template provides access to macros specific to the study as well as previously dictated entries for particular fields, to enable re-use of standard text in a contextual manner. Likewise, entry of text in one field of the report may cause related text to be propagated to other fields, such as from the findings to the impression, automatically as specified by the radiologist. Billing codes are automatically applied based on the report content. Communication by the radiologist with other physicians and institutions is implemented via the reporting system. Since communication instances pass through the radiology system, it is possible to associate and log communication instances with the studies.

### CROSS-REFERENCE TO RELATED APPLICATIONS

This application is a divisional of U.S. patent application Ser. No. 13/748,317, filed Jan. 23, 2013, which claims priority to PCT Application No. PCT/US2011/51282 and to U.S. Provisional Application No. 61/382,301, filed Sep. 13, 2010, the content of each of which is hereby incorporated herein by reference.

### TECHNICAL FIELD

The present invention relates to radiology systems, and, more particularly, to a teleradiology system.

### BACKGROUND

Medical diagnostic imaging allows radiologists to perform diagnosis of many types of injury and disease by imaging various internal body parts. For example, radiologists utilize diagnostic imaging to visualize organs in the abdomen, the chest cavity, the brain and central nervous system, and the musculoskeletal system. Diagnostic imaging may be used to detect potential cancer abnormalities; bone densitometry; joint, bone, or soft tissue injuries; and many types of diseases. Presently, diagnostic imaging includes many different types of imaging technologies such as x-rays, ultrasound (“US”), computed tomography (“CT”), magnetic resonance imaging (“MRI”), and nuclear medicine (“NM”) to name but a few.

Traditionally, almost all diagnostic imaging was film based. An image was recorded on a physical piece of film that had to be developed, provided to the physician for viewing, reviewed by the physician, and recorded and stored in an archive. Often there was a significant time delay between the taking of the image and the physician reviewing the image. If additional images were needed to complete the diagnosis, the patient was required to return to the imaging facility at a later date. In addition, the storage of film images required a large physical space and associated record keeping which, for example, may use paper files or files in a computer database. If a physician needed to refer to a patient's stored records, the film images needed to be physically found, retrieved, and provided to the physician. Often there was a significant time delay in this process as well.

To address these issues, diagnostic imaging technology has advanced and medical diagnostic imaging has shifted from a film based system, to a digitally based system in which diagnostic images are recorded, transferred, viewed, and stored electronically. Images captured by imaging modalities are stored in an image archiving system, which is commonly referred to as a Picture Archiving and Communication System (PACS). A PACS provides an integrated system that receives image data from one or more imaging modalities, processes the image data as needed, stores the image data within a database, retrieves the data when required, and serves the data to be displayed for review by the physician or a technician. Because the PACS includes multiple pieces of equipment that are often manufactured by different manufacturers, a standard data format and protocol have been developed to allow communication and exchange of medical data among the various equipment manufacturers. This standard, developed by the American College of Radiologists and the National Electrical Manufacturers Association, is commonly referred to as Digital Imaging and Communications in Medicine (DICOM).

There are multiple scenarios where patients may need radiological imaging. In one scenario, a patient enters the emergency department of a hospital. A physician orders imaging and the order is entered into the Hospital Information System (HIS). The HIS communicates the order for a radiological study to a Radiology Information System (RIS) or to the Picture Archiving and Communications System (PACS). The PACS or RIS prepares a list of open orders for the modality (X-RAY, CT, etc.). When the patient arrives at the modality, the technologist associates the patient with an order and acquires the image(s). The image(s) are collected into series. All the series together are known as a study. As each series is acquired, it is sent to the PACS for storage and distribution. At a later time, a radiologist will view the images to help determine a diagnosis for the patient. The radiologist may be connected to the hospital network or, alternatively, may view the images in the study remotely. Since radiologists have a limited amount of time to view the images and provide comments, it would be desirable to provide an improved teleradiology system to enable increased radiologist efficiency.

### SUMMARY

The following Summary and the Abstract set forth at the end of this application are provided herein to introduce some concepts discussed in the Detailed Description below. The Summary and Abstract sections are not comprehensive and are not intended to delineate the scope of protectable subject matter which is set forth by the claims presented below.

A teleradiology system provides for prefetching of prior studies associated with a given patient from multiple institutions and making those prior studies available to the radiologist while the radiologist is viewing images associated with a given series. Intelligent report generation is template driven with templates based, for example, on institution, modality, body part, and radiologist. The template provides access to macros specific to the fields of the report as well as previously dictated entries for particular fields, to enable re-use of standard text in a contextual manner. Likewise, entry of text in one field of the report may cause related text to be propagated to other fields, such as from the findings to the impression, automatically or under the control of the radiologist. Billing codes are automatically derived and applied based on the content of the report to facilitate billing. Communication associated with the report is available via the reporting system. All communication instances pass through the radiology system to enable logging of communication instances associated with studies reviewed by the radiologists.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labelled in every figure. In the figures:

FIG. 1 is a reference network showing components of a teleradiology system interconnected via a communication network;

FIG. 2 is a flow chart showing one aspect of operation of an example teleradiology system;

FIGS. 3-11 are screenshots of a user interface of an example teleradiology system; and

FIGS. 12-15 are example communication instances that may be communicated through an example teleradiology system.

### DETAILED DESCRIPTION

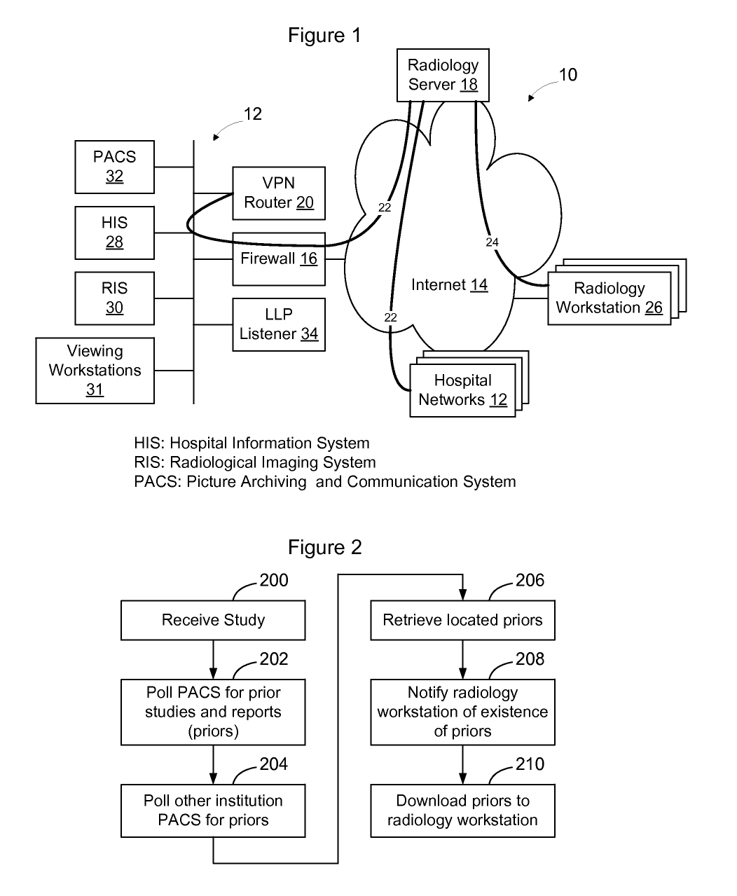

FIG. 1 shows a reference network 10, in which a hospital network 12 is connected to the Internet 14 via a firewall 16. Communication of data between the hospital network and designated servers such as Radiology Server 18 on the Internet 14 is protected using VPN router 20. The VPN router enables a VPN tunnel 22 to be established to encrypt and/or encapsulate traffic for transportation over the Internet in a secure manner. Similar tunnels 24 may be established between the radiology server 18 and radiology workstations 26, which are used by radiologists to review studies under the management of the radiologist server 18. Although not shown in FIG. 1, a VPN router is also implemented at radiology workstations 26 to enable the VPN tunnels 24 to be established between the radiology server 18 and radiology workstations 26.

The hospital network 12 includes a hospital information system 28. One or more imaging modalities configured to generate medical image data are connected to the hospital network 12. Typical imaging modalities might include, without limitation, an x-ray system, a computer tomography system, an ultrasound system, a magnetic resonance imaging system, or a nuclear medicine system. Other modalities may be used and the invention is not limited to these particular modalities. The modalities may create medical image data in a DICOM compliant image data format, or a non-DICOM compliant image data format depending on the implementation. Where the modality creates non-DICOM compliant images, a DICOM gateway may optionally be used to reformat the image data into DICOM compliant image data if that is the intended format of the data.

A Picture Archiving and Communication System 32 receives images from the imaging modalities, stores the images, and provides the images on demand or as acquired to other PACS and to the viewing workstations 31 connected to the hospital network. A radiological imaging system 30 may be provided to provide scheduling and report management.

In the embodiment shown in FIG. 1, radiology server 18 interacts with the PACS 32 to enable remote viewing of images. This allows radiologists working at radiology workstations 26 to view the images rather than or in addition to having the images viewed at the viewing workstations 31 connected to the hospital network.

The PACS system 32 sits behind the firewall 16, which interfaces the hospital network 12 with the public Internet 14. The radiology server 18 works with the VPN router 20 within the hospital's private network 12 to establish private VPN tunnel 22 between the radiology server 18 and the hospital private network. The Virtual Private Network (VPN) tunnel will be referred to herein as the VPN. The VPN router may be a stand-alone component or an instantiation of a virtual router on another router/server within the hospital network. The hospital's HIS/RIS and PACS connect to/from the radiology server 18 over this private tunnel.

In addition, the radiology server 18 provides web application services to the radiology workstations 26 using secure http (HTTPS) which uses Secure Socket Layer (SSL) or Transport Layer Security (TLS) for encryption. VPN tunnel 24 is used to transmit DICOM studies from radiology server 18 to radiology workstations 26.

The radiology servers 18 provide a mix of services over the VPN 24 as well as the web-based services mentioned above. The VPN 24 is used for bi-directional distribution of DICOM studies and for the remote control of the DICOM viewer. The secure web services are used for all other activities, including the display of worklists, the creation and dictation of reports, follow-up communication and peer-review.

The radiology server 18 discovers new studies and obtains the studies for distribution to the radiology workstations 26. There are several ways for radiology server 18 to learn of new studies as the new studies are created. First, the HIS/RIS can notify the radiology server through a “LLP listener” 34. The LLP listener is a piece of software that opens a particular IP port number and listens for Health Level Seven (HL7) message data to be sent to it by another HL7 message sending application (router). For example, the LLP listener may obtain information about a new order when it receives a HL7 Observation Result Message (ORM). Second, the hospital PACS system may be set to automatically forward, via DICOM C-MOVE, all studies matching certain criteria (time of day, modality, priority, etc.) to the radiology server 18. Third, the radiology server 18 can poll the PACS system using DICOM query messages to discover the new studies. Fourth, an order for the study may be entered via the web application by the radiology workstation.

When the radiology server 18 learns of a study, it obtains a copy of the study to enable the study to be viewed on one or more of the radiology workstations 26. Initially, when the radiology server 18 learns of a study, but does not actually have the study, the study is placed in a queue to be fetched. A daemon continually analyzes the queues of studies for distribution, to and from hospitals and to and from radiologist workstations. The radiology server 18 is thereby able to keep track of which series exist, and which are present on each workstation within its network. Movement of studies between components of the system may be accomplished using Service Class User (SCU)/Service Class Provider (SCP) DICOM messages in a normal manner.

When a study arrives at the radiology server 18, it is parsed for relevant details (e.g. patient name, modality, technologist notes, orientation, etc.), added to a database maintained by the radiology server, and presented on the worklist. On each radiologist workstation, the progress of transfer of series within that study to the local workstation is displayed on the worklist.

As discussed in greater detail below, there are occasions where it is advantageous for the radiologist to have information about other previous studies that have been completed for the same patient. According to an embodiment, when a new study arrives, the system examines the incoming study to discover the source institution and information about the patient. Based on which institution the study is from, one or more other PACS systems in other hospital networks or associated with other institutions 12 are queried for prior studies from the same patient. When those studies are discovered, the related prior studies are added to the queue of studies to be fetched. Prior reports, technician notes, lab reports, or other medical records may also be retrieved along the studies (images) and provided to the radiologist.

The existence of prior studies is indicated on the worklist in a pane used for presentation of other relevant data to the radiologist. The existence of prior studies may appear before the prior studies have completed being transferred to the radiology system. If a radiologist begins interpretation of the new study before the desired prior study is available, the radiologist has the option of waiting for the prior study to become available or the radiologist may interact with the worklist to advance the prior study to the head of the transfer queue. When the related studies are received, the related prior studies are added to the database and then made available to the radiologist when the radiologist is reviewing the new study for the patient.

The radiology server may prioritize fetches using any number of criteria, including new vs. old studies, modality, body part, and likelihood of patient match. Other ways of prioritizing which studies are fetched, and the particular manner of ordering how studies are fetched, may be utilized as well.

Patient matching may be done by patient ID within the same facility. Across facilities, patient matching may be performed by name and date of birth. Other matching may be for similarity of name (e.g. Jon vs. John where the names may sound alike). Phonetic algorithms which index names according to sound rather than exclusively on spelling, such as soundex, may be used for example to identify possible previous studies.

All studies are displayed on the radiologist worklist for which that radiologist is credentialed to read. The radiologist may optionally filter the worklist (e.g. show only unread studies, show only studies from a particular institution, etc.). The radiologist may also elect to have the worklist sorted (e.g. STAT (immediately due) cases at the top, sorted by study date/time, etc.).

When a radiologist selects a particular study, all prior studies and reports for that patient are shown in a different panel. The radiologist may elect to view any of the prior studies and reports. An algorithm may select and suggest one or more prior studies for inclusion in a hanging protocol. A hanging protocol, in this context, is set of actions performed to arrange images for optimal softcopy viewing in PACS context. The goal of hanging protocol is to increase Radiologists efficiency by saving the time radiologists perform in manual reordering of the images for viewing for diagnosis. A hanging protocol ensures the consistent presentation of images of particular study type. Hanging protocols vary based on modality, body part, department, personal preference etc. In the context of pre-fetching prior studies, the algorithm implemented in the hanging protocol may sort and select studies based on modality, study description, body part, date, or other factors.

When a radiologist is using the radiologist workstation to read radiological studies, there generally are three “programs” running on the workstation 26. One of the programs is the worklist, which, in one implementation, is a web application implemented by radiology server 18. The second application is the image viewer, which acts as a server taking requests for display from the remote client. The remote client, in this context, is the radiology server 18. The third application running on the radiologist workstation, is the reporting application.

The reporting application, in one implementation, is a web application that waits for the radiologist to open a study for reporting. When the radiologist opens the study, depending on the status of the study, different reporting capabilities are made available. For example, if a report has already been approved, the reporting application opens for dictation of an amendment. If a preliminary report has been submitted, perhaps by a resident, the application opens for approval or rejection of that report. If another radiologist is editing a report for that study, the radiologist who would like to also work on the report is presented with the option of requesting to take over that report. If the radiologist selects to request a take over, the second radiologist who is currently editing the report is given the option to accept or reject that request. If the second radiologist doesn't respond within a certain amount of time (for example 60 seconds), the system acts as if the second radiologist had accepted the request. In any event, all requests are logged and interested parties are notified by email. Alternately, there may be a draft report that another user has saved. If there is, the radiologist is notified that the draft report exists and is given the option of taking over that report. If the radiologist elects to do so, the other radiologist and other interested parties are notified. The reporting application is thus intelligent, and provides the radiologist with a particular set of options depending on the status of the report accessed by the radiologist.

In the event that there is no report for the study that has been opened, the reporting application opens for the dictation of a new report. All reports are driven by a template. The templates are predefined and stored in the database on the server. Based on the institution, the reading radiologist, and the study description, a template is pre-selected. The radiologist has the option to use that template, to use a different one, or to use multiple templates. The default template is said to be associated with that combination of radiologist, study description and institution. The radiologist also has the option to change that association to a different template.

During dictation of a report, the radiologist may optionally either cancel the dictation, in which case that study closes, or save the report as a draft to continue later. If the radiologist saves the report as a draft, the status of the study is also shown as draft. If the radiologist subsequently reopens that study, the report will automatically be reopened to allow the radiologist to resume editing the draft report. When the report is complete, the radiologist, through either voice command or button click, signs and sends the report.

Once a report is complete, the complete report is sent via secure connection to the server where it is entered into the database. The report is also converted to a DICOM Structured Report (SR) and optionally queued to be sent to the RIS/PACS of the institution of origin via DICOM C-STORE. The daemon periodically evaluates the queue of reports, to see if there are any reports that need to be sent via HL7 to a HIS/RIS. When the report is entered into the system, it may also be sent via facsimile. It may also cause an email or an SMS to be sent to the referring physician or other users advising them that a report is available. The referring physician may then view the report through a physician's portal or through another interface provided for viewing reports available via the radiology server.

In one embodiment, the radiology server 18 may be implemented using redundant Linux servers. The data and code set for the application is duplicated across the servers using DRDB™, available from LINBIT of Australia. DRDB may be thought of a network-based RAID 1 replication system that replicates data between servers. Layered on top of DRDB is a corosync/heartbeat/pacemaker system for high availability. The redundant VPN routers poll for availability of service on the two servers. The routers send all traffic to the server that is active. In the event of a server failure, the other server immediately picks up service using the same code and data, the router directs traffic to the now active server. A third server arbitrates the active state of the first two servers such that a quorum of two is required for a server to become active. The VPN router has a hot standby that automatically substitutes including absorbing connection state and MAC addresses. Redundant internet connectivity supports increased uptime. Redundant and isolated uninterruptible power supplies, redundant server power supplies, and RAID-6 drive arrays all assure high availability. Continuous monitoring of multiple parameters, from drive/array state to server/UPS temperature to connectivity provide greater assurance. Security is implemented on the servers to prevent unauthorized access.

The reporting application, in one embodiment, is a web application which provides numerous other capabilities, including improved communication and follow-up (see below), automatically assigned peer review, productivity tracking, and invoice generation. A referring physician portal allows other users to view reports and images from any internet connected device, to communicate with other users, submit tickets for Quality Assurance (QA), and forward reports to other users or FAX terminals. Communications associated with studies reviewed by radiologists pass through the radiology server enabling the communications to be logged and associated with studies. In one embodiment, the teleradiology system provides access to previous studies in connection with the current study, facilitates report generation, provides an easy way to allow participants to communicate with each other, and enables follow-up communication for completed studies.

Typically when radiologists work remotely in a teleradiology scenario, the client hospital pushes studies to the teleradiology service for interpretation. Often, interpretation is done without benefit of prior images and reports. In the event the radiologist wants access to a prior study, the radiologist may call a technologist at the client hospital and ask what prior studies are available. Based on a verbal description, the radiologist may request that another one or more studies be transmitted from the hospital electronically. After all transmission is complete, the radiologist may then render an interpretation including benefit of prior studies. Although this system is inefficient in making prior studies available, it can be quite efficient in allowing a teleradiology service to provide service to multiple hospitals on disparate PACS.

This contrasts with the way radiologist work when on a PACS workstation local to the hospital, e.g. when viewing images on viewing workstation 31. When a radiologist works on a local PACS workstation, whenever the radiologist selects a new study, information on all available prior studies known to the PACS is presented to the radiologist. If the radiologist wishes to view any of those priors, the prior related studies can be displayed on the local workstation. While this approach may make priors from that institution available, it makes no use of priors from other institutions.

A hybrid model is sometimes used wherein a radiologist works on a PACS workstation remote to the hospital. In this case the radiologist may be able to see a listing of all prior studies and reports for a patient. If the radiologist elect to have one of them displayed, that study is transmitted from the PACS server to the remote PACS workstation, perhaps in a compressed fashion, and is then presented to the radiologist for reference in rendering their interpretation. While this approach may make priors from that institution available, it makes no use of priors from other institutions and can incur significant time penalties since the prior is not transferred to the radiologist workstation until needed, and the radiologist typically has to wait for the prior to arrive over the network before being able to analyze the current study in view of the information contained in the prior studies.

According to an embodiment, when a new study arrives at the radiology server 18, the DICOM Queries are sent to at least some of the attached PACS inquiring as to the existence of prior studies. Based on the source (institution) of the new study to be read, different client PACS may be queried. The priors may be matched by patient name, patient birthday, patient ID, modality, body part, or other means.

In the event that a potentially relevant prior is found, the radiology server queries its database or local PACS to determine if it has a copy of that study. If it does not, a DICOM C-MOVE request is issued to the client hospital PACS for transfer of that study. Once the study arrives at the radiology server, it is made available to be distributed to the relevant radiologist workstations.

The existence of potentially relevant priors are noted on the radiologist worklist as soon as the system becomes aware of their existence. The status of the prior studies (requested, being transferred, transfer complete) is also presented. When the radiologist selects the new study to interpret, the relevant priors are presented and the suggested prior is selected for use in a comparison display with a hanging protocol. The radiologist is also given the option to select alternate prior studies or no prior studies for comparison.

When the radiologist selects to view the images, the viewing workstation presents the images associated with the current study, as well as optionally the images associated within one or more prior studies, directly and without requiring the radiologist to wait. Specifically, since the current study and priors have been pre-fetched to the viewing workstation, there is no time spent waiting for their transfer over Internet 14.

Providing the radiologist with prefetched priors allows relevant priors to be made available to the radiologist without requiring the radiologist to manually request that the priors be obtained and made available. This increases efficiency, by allowing the radiologist to perform more of the review in one sitting. Specifically, it reduces the likelihood that the radiologist will need to put their review of a study on hold while prior studies are requested from remotely located PACS systems and downloaded over the network. Moreover, since the radiology server is connected to PACS systems associated with multiple hospital networks 12, prior studies and reports (priors) from multiple medical institutions may be provided to the radiologist. Thus, the radiologist may interpret the current study in a more complete context to hopefully more accurately assess the information contained in the current study.

FIG. 2 shows an example flow chart of how the radiology server 18 may operate in connection with one embodiment. As shown in FIG. 2, when the radiology server receives a study (200) it will poll the PACS that sent the study and other known PACS for prior studies and reports associated with the patient (202). Likewise, the radiology server will poll other institution PACS for other priors associated with the patient (204). If one or more priors exists, the radiology server will retrieve the priors (206) so that they are all present on the radiology server and are downloaded to the radiology workstations 26. The radiology server will notify the radiology workstation of the existence of the priors (208) and, if the priors have not been downloaded, the radiologist may select one or more of the priors to be prioritized for downloading by causing the selected prior to be moved to the head of the download queue. The radiology server will download the priors to the radiology workstation (210) so that the priors are available to the radiologist in the context of evaluating the current study.

While reviewing the images associated with a study, and once the radiologist has finished reviewing the images, the radiologist will generate a report indicating what images were reviewed, and what the images showed. Generating reports can be time consuming for the radiologist. To save time, most medical reports are dictated. Historically reports were transcribed and then reviewed by the reporting physician. As improvements have been made in voice recognition technology, dictation has started to be replaced with direct report generation with physician self-editing.

In order to make physicians more productive, and in order to reduce dictation errors, a number of voice dictation reporting software packages use macros to expand short phrases into longer phrases. For example, a macro may allow expansion of a short phrase such as “normal” to a longer phrase such as: “The lung fields are clear bilaterally. There is no evidence for focal inflammatory abnormality or consolidation. There is no evidence for vascular congestion.”)

However, the term “normal” means different things when used to refer to different parts of the human body. For example, the word “normal” when used in the context of a person's lungs is different than when used in the context of the same person's bones. Accordingly, the physician would need to use different words to invoke different macros, even in a simple instance such as the one described above, where the physician is intending to state that the particular system being reviewed appears “normal.” Moreover, depending on the particular way in which the particular system is being viewed, the physician may prefer to use a different phrase to describe what is considered to be “normal” for the system. For example, a physician may describe the lungs as “normal” using one phrase when the lungs are being viewed in the context of a chest x-ray (previous description), and use a different phrase to describe the lungs as “normal” when the lungs are being viewed in the context of a x-ray Computed Tomography (CT), e.g., “The lung parenchyma is unremarkable. The airways are widely patent.”

According to an embodiment, different macros are available to the radiologist based on the template being used to create the report. The selection of template may be based on which radiologist is dictating the report, what modality was used to perform the study, which institution ordered the study, and based on which organ or part of the anatomy is being reported. Other factors may be used to select a set of macros to be made available to the radiologist. The factors (physician, institution, modality, body part, etc.) provide context for selection of a particular template. The template in turn, provides context to the reporting software to enable the software to select macros for presentation to the radiologist in connection with the study. Additionally, based on the context, each macro made available to the radiologist has a different meaning, a different expansion, in each part of the report, in each type of report, and potentially for each reporting radiologist. Enabling macros to be made available in a context specific manner facilitates selection of the correct macro based on the body part being examined, and allows different macros to be used to describe the same body part for different institutions, different modalities, and for different reviewing radiologists.

The radiologist is provided with a number of ways to select from available macros to populate portions of the report. For example, in one embodiment a set of available macros is determined by the reporting application hosted by the radiology server, given the type of study being reviewed by the radiologist, the particular organ or portion of the anatomy associated with the study, etc. These available macros are displayed to the radiologist, and may be selected by a radiologist by dictating, e.g. by speaking the name of the macro, by clicking on the macro, or by dragging and dropping the macro to a given field of the report. In one embodiment, mousing over the macro will cause the text associated with the macro to expand so that the radiologist is able to see the full text of the macro prior to selecting the macro.

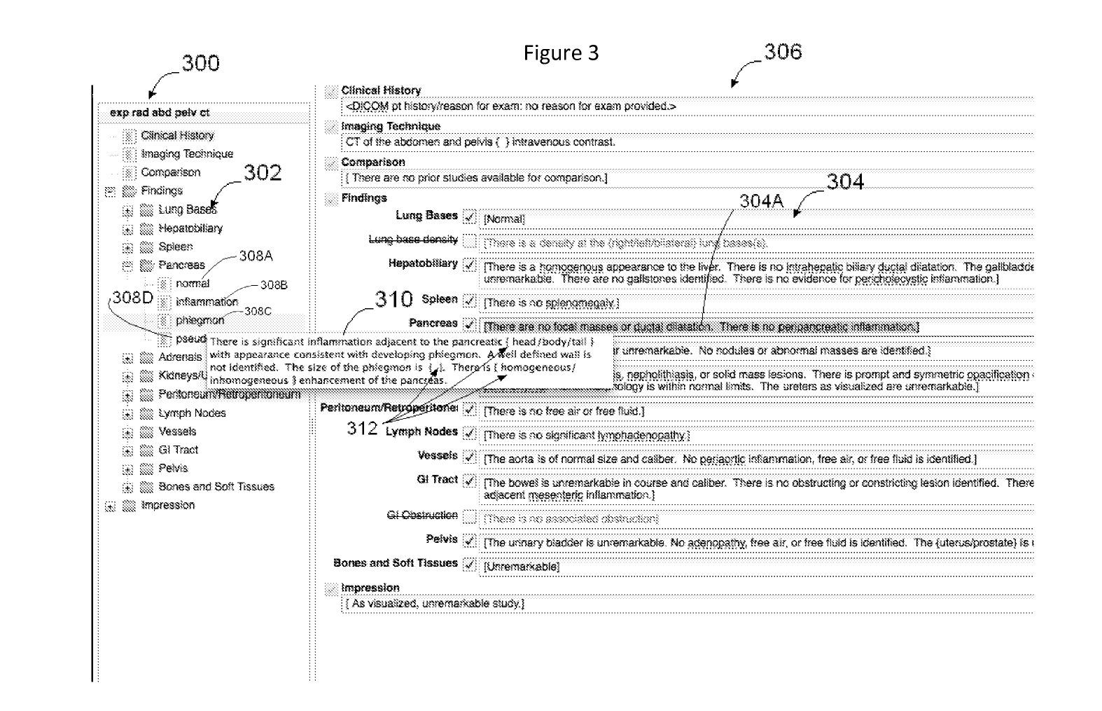

FIG. 3 shows an example user interface of a reporting application according to an embodiment. As shown in FIG. 3, the reporting interface has a menu 300 containing menu elements 302. A more detailed indication of the content associated with under particular menu elements appears in fields 304 of report 306. In one embodiment, the report may be divided into predefined sections which may include, for example section headings such as Imaging Technique, Findings, or Impression.

The overall structure of the report is referred to herein as a “template”. The template specifies the menu items 302 available to the reporting radiologist. The templates are statically defined, and may vary as a function of reporting radiologist, modality, institution, study type, or other factors. A particular template may include menu items for each relevant body part or organ. Fields 304 in the template are associated with menu items 302, and show the text that will be entered into the report upon completion of the report. Since there may be many fields available via the menu items associated with the template, in one embodiment the level of detail (i.e. the number of fields) which appears on the radiologist's screen corresponding to a particular menu item depends on whether that menu item has been selected or deselected by the radiologist via menu 300.

The menu elements, in one embodiment, are hierarchically arranged such that selecting a particular element in the menu will cause other sub-elements to be displayed in the menu. As sub-elements are displayed in the menu, corresponding sub-fields of the template are also displayed in the report viewing section, e.g. in report 306. In the illustrated example, the menu appears on the left hand-side of the user interface and the report viewing area appears on the right-hand side of the user interface, although the particular location of the user interface elements may be set according to preference.

In the example illustrated in FIG. 3, the menu includes two top level elements labelled “findings” and “impression”. The radiologist, in this example, has selected the “findings” element by clicking on the element. When the “findings” element was selected, a set of sub-elements were displayed, including “Lung Bases” “Hepatobiliary”, “Spleen”, etc. Each of these sub-elements may be further selected to cause additional sub-elements to be displayed. In the illustrated example, the radiologist has selected the “Pancreas” sub-element.

The elements 302 and sub-elements shown in menu 300 are thus selectable to provide the radiologist with access to macros 308 (308A-308D), which allow the radiologist to select text to be entered into the field 304 of the report which corresponds with the selected sub-element. The macros 308 are different from the menu elements, since macros do not have additional sub-menu elements but rather provide text that will be entered into a field of the report when selected by the radiologist. For example, in FIG. 3, menu element “pancreas” 302 has been selected to expose four macros 308A-308D that may be selected by the radiologist. These macros are thus presented in the context of the menu element “pancreas” and are specific to that particular body part. Moreover, the macros available to describe the pancreas are specific to the type of study that is being done, e.g. specific to the institution that ordered the study, the modality that was used to perform the study, and optionally are also specific to the radiologist that is reviewing the study. When the radiologist selects the particular macro to describe what is observed in the study, the text of the macro will be inserted into the associated pancreas field 304A of the report.

By grouping the macros in a hierarchical manner, the macros associated with different anatomy may be organized and presented to the radiologist in an intuitive manner. For example, as shown in FIG. 3, when the radiologist is working on a Pancreas study, the radiologist can select the Pancreas element in the menu to cause available macros associated with common findings to be presented for selection and entry in to the report. By hovering a cursor over a particular macro, the text of the macro will be displayed in a tooltip or other popup area so that the radiologist can read the text associated with the macro prior to selecting the macro to populate the field of the report. In FIG. 3, the radiologist has caused the mouse cursor to remain stationary over a macro 308C “phlegmon” to cause the text associated with that macro to be displayed in box 310. If the radiologist were to then select that entry, e.g. by clicking on macro 308C or audibly dictating the name of the macro, the text associated with the macro would be used to replace the text currently shown in field 304A of report 306.

Once an entry has been selected, the text that is populated into the report may include variable fields 312 that require input from the radiologist. Within the text, these fields are identified to the radiologist using curly braces “{ }”. Other symbols may be used to identify fields that must be completed by the radiologist. For example, in the text displayed in box 310, one of the fields 312 that must be completed by the radiologist allows the radiologist to specify the size of the phlegmon. The use of curly braces or other delimiters helps identify to the radiologist what measurements need to be made and which observations should be specified for the particular condition. If one or more of the fields associated with the delimiters is not completed by the radiologist, a warning may be provided to the radiologist when the radiologist tries to end the report to help ensure that the entry is completed and that all the necessary observations are provided before the report is submitted.

The same macro label may be used in different elements 302 of menu 300, and include different text in each instance. For example, the macro labelled “normal” under the menu item “Pancreas” would contain different text than a macro labelled “normal” under the menu item labelled “Spleen”. Thus, the macros in one embodiment are context sensitive since the content of the macro depends on the context of the menu element through which the macro was accessed.

Additionally, different institutions may have individualized ways of describing the study and the reasons for the study. According to an embodiment, institution specific text may be automatically included so that when a study arrives, and the radiologist opens the study to start work on the study, the reporting application will load macros into the reporting application specific to the originating institution from which the study was received.

Likewise, different radiologists may have preferences as to how particular conditions are described. Accordingly, the text of the macros may be customized by the radiologists and saved for subsequent use with similar studies. Thus, in one embodiment, the macros are automatically selected according to the radiologist performing the review of the study.

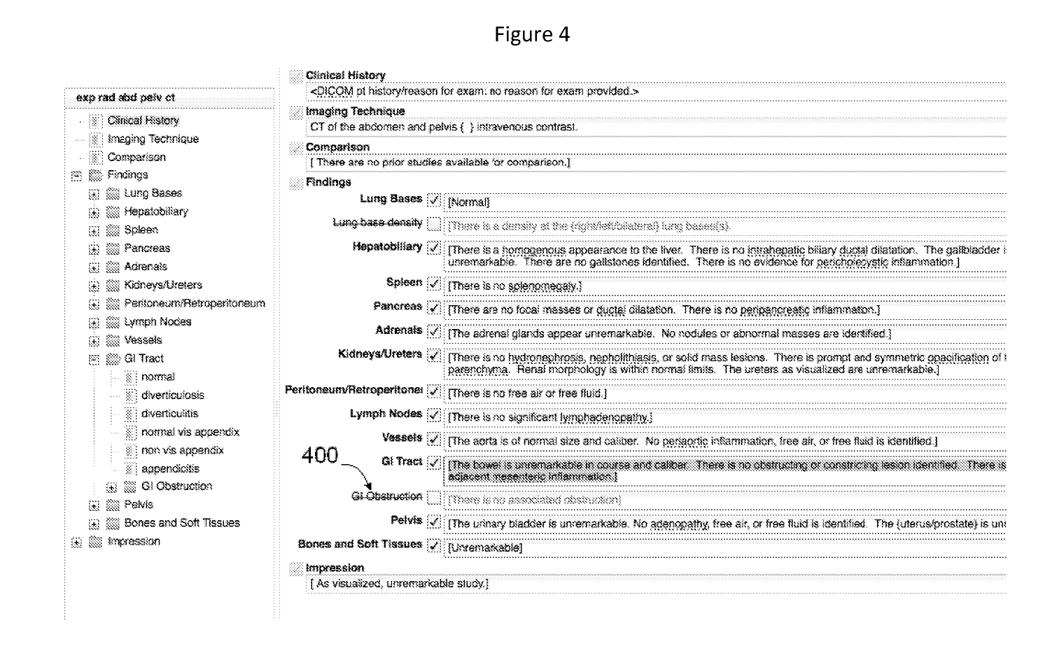

The menu items available to the radiologist on menu 302 may be statically set, or alternatively, may dynamically be added to the menu based on other entries made by the radiologist. For example, based on the text that is selected for a particular field in the template, other headings or subheadings may become available in the menu. For example, FIG. 4 shows an initial report prior to entry of a finding indicating that the radiologist detected diverticulitis in the gastrointestinal (GI) tract. Note, that field 400 related to GI Obstruction is disabled in FIG. 4.

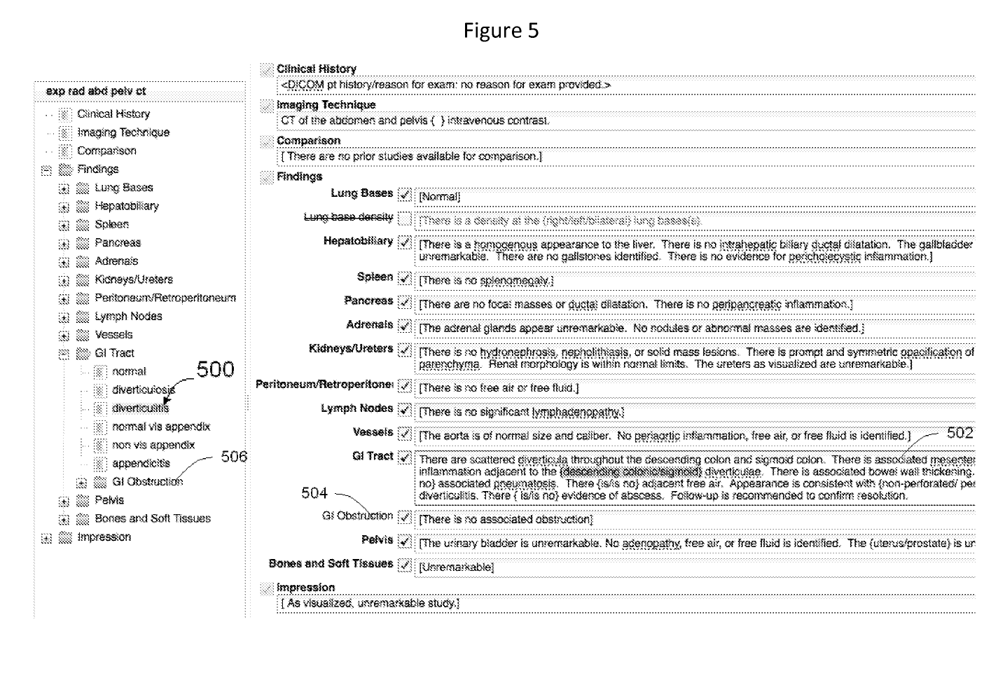

In FIG. 5, the radiologist has selected the macro 500 associated with a finding of diverticulitis. When the radiologist selected this macro, the text associated with the macro was inserted into the field 502 of the report associated with the GI tract. In addition, selection of this macro caused the GI obstruction field 504 to switch from inactive as shown in FIG. 4 to active as shown in FIG. 5. Thus, the ability of the radiologist to access fields of the template may be predicated on previous entry of earlier findings in other fields of the report. When the field becomes active, as shown in FIG. 5, the macros associated with GI Obstruction may be accessed through menu element 506.

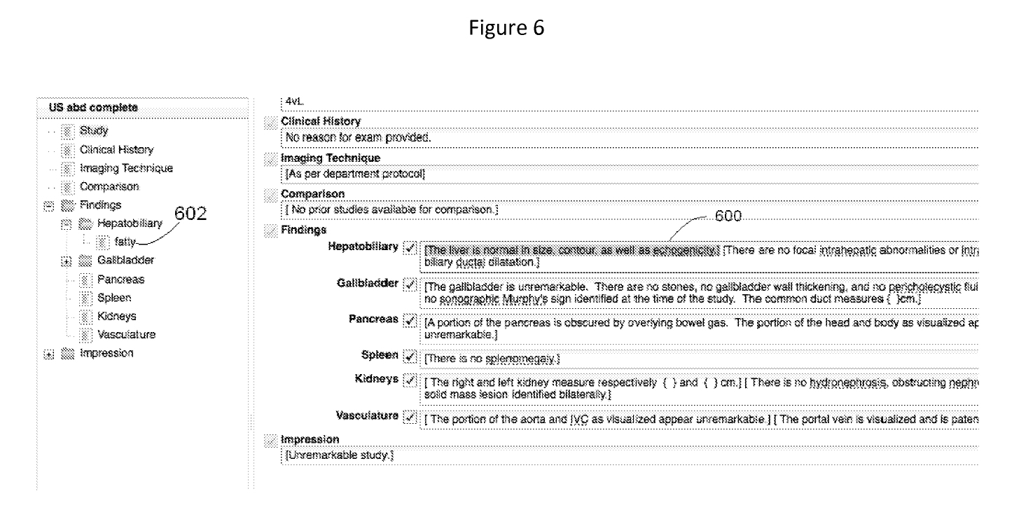

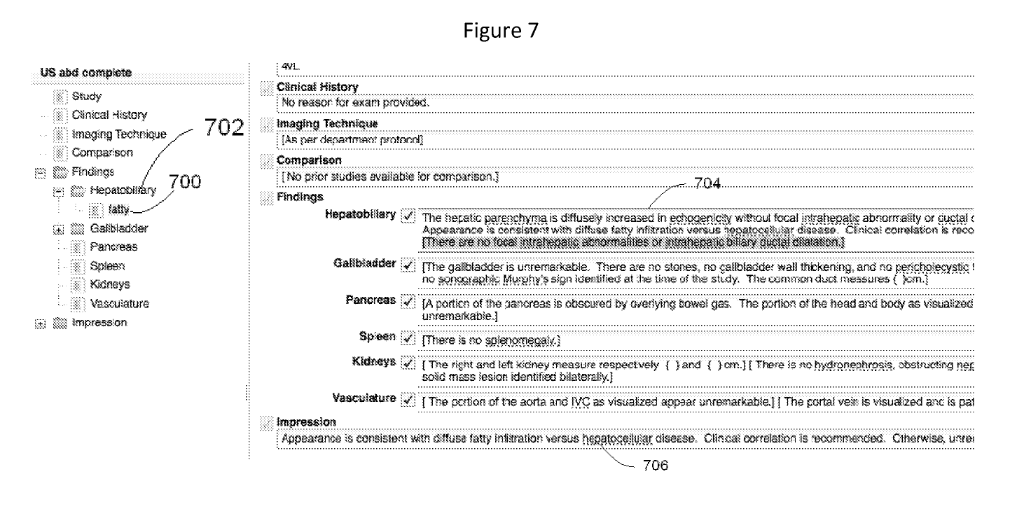

The dynamic report template generation also allows for the propagation of text between fields. For example, as shown in FIG. 6, the default text is visible in field 600 under the subheading of hepatobiliary, and the impression contained in that field contains the default text for a normal abdominal ultrasound. However, as shown in FIG. 7, when the macro “fatty” 700 is chosen under the Hepatobiliary menu element 702, not only is the macro expanded into the Hepatobiliary field 704, but also appropriate text is inserted into the Impression field 706 consistent with Hepatobiliary disease. Thus, selection of a given macro such as macro 700 may cause text to be inserted into more than one field of the report, such as into both the Findings field and the Impressions field.

One section of every report is “Findings.” The findings describe what the radiologist observes. Another section of every report is the “Impression.” The impression summarizes the observations and may tell what the findings mean, or suggest next steps. Frequently, a radiologist will first dictate the Findings and then dictate the Impression. For various reasons, the Impression usually discusses a subset of the Findings, although this is not always the case.

According to an embodiment, the reporting software allows the radiologist to propagate part of the findings to the Impression, by causing some of the text included in the Findings to also be included in the Impression. For example, while dictating the findings, pressing a button on the microphone or a combination of buttons on the keyboard will cause the most recently dictated sentence to be copied to and added to the impression. In this embodiment, if the radiologist determines that there is a finding that should be mentioned in the impression, instead of having to dictate the sentence a second time, the radiologist can propagate the sentence from the findings to the impression by having the reporting software enter the sentence in both locations on the report.

In addition to accessing macros through the menu, radiologists are also able to access macros through dictation. Voice recognition and dictation software often includes the concept of macros—the idea that a short phrase can be expanded to a pre-set longer phrase. In this context, the term “phrase” is not used to refer to the grammatical definition of phrase, but rather a phrase is some number of words which, when dictated, will be expanded by the system into a larger group of words, up to a paragraph or more.

According to an embodiment, whenever a report is saved, either in draft form or signed and submitted, the entries that the radiologist has dictated for each field are recorded in a database. When that same template is later used by that same radiologist, those previous entries are accessed. When a particular field is selected, not only are the macro choices for that field made available to the radiologist, but also the text that the radiologist has previously dictated in that field in connection with other previous studies (e.g. in connection with reviewing studies of other patients which are similar to this study in terms of type of study and modality). Since the previously dictated entries are selected for presentation to the radiologist based on the particular field of the report, underlying context of the report is thus able to be used to sort a database of previously dictated entries to only provide the radiologist with a set of previously dictated entries that are relevant to the particular field being completed by the radiologist. The radiologist can select these previously dictated entries, which the radiologist created in connection with previous reports, to cause that text to be inserted into the appropriate field of the current report. The radiologist may select the text using a mouse click, keystroke, by voice (i.e. “history four”), or in some other manner, which will cause the previously used text to be inserted into the current field.

Over time, the history of phrases used by the radiologist may tend to accumulate. Thus, in one embodiment, the phrases are sorted to provide the radiologist with the most recently used phrases at the top of the list and the least recently used phrases towards the bottom. Additionally, the radiologist may mark a phrase to indicate to the system that the phrase is to be maintained in the list, maintained at the top of the list, maintained at the bottom of the list, etc. For example, it may be that there a particular condition is rarely encountered. For practical purposes, not every phrase may be maintained in the list and, accordingly, less used phrases will tend to be dropped from the cached history list. By allowing the radiologist to mark phrases to be retained in the history lists, the radiologist may keep entries in the history list for rarely occurring conditions so that the content of the list may be controlled by the radiologist.

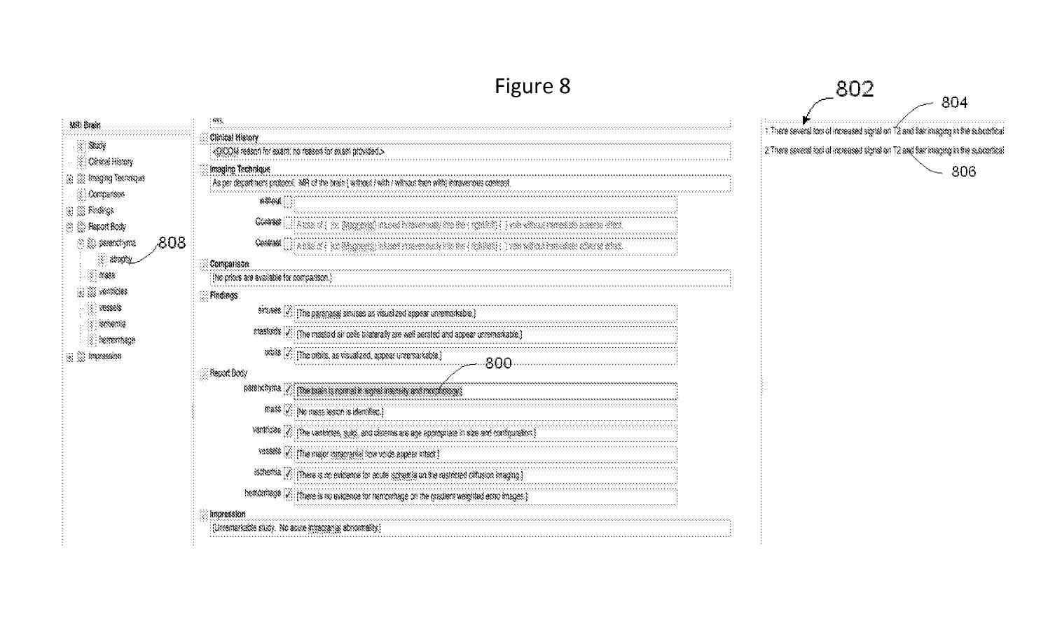

FIG. 8 shows a report template with the brain parenchyma field 800 selected. When this field is selected, the text contained in the field is highlighted. Likewise, selecting this field causes a history list 802 to appear on the right containing entries 804, 806, of previous entries that the radiologist has entered into other reports where an entry was made in the brain parenchyma field. These history entries are macros containing descriptions the radiologist entered into other reports of other patients at some earlier time.

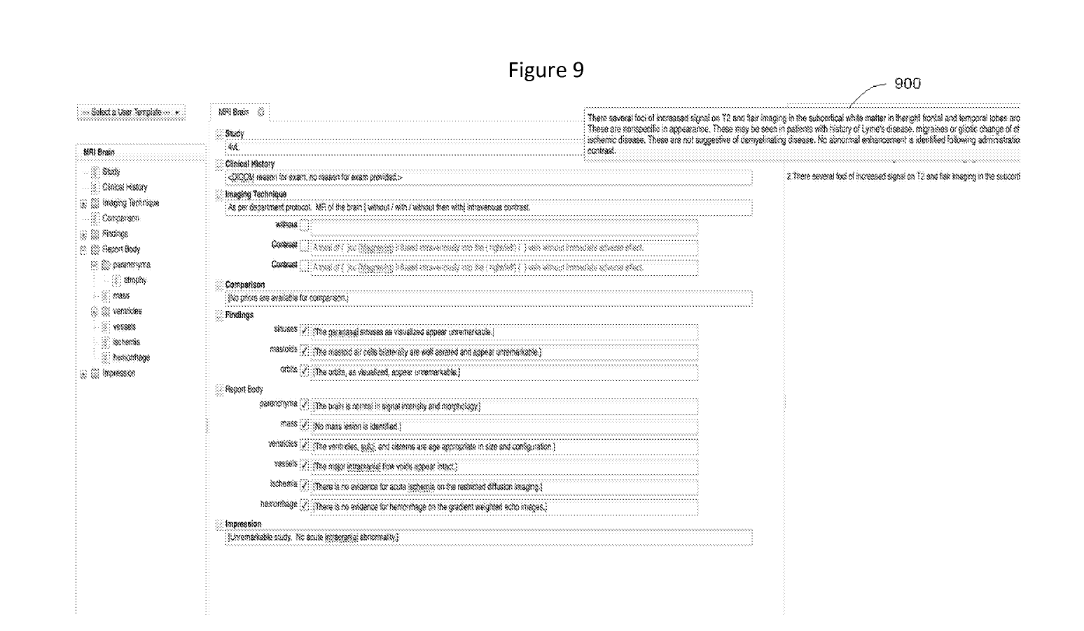

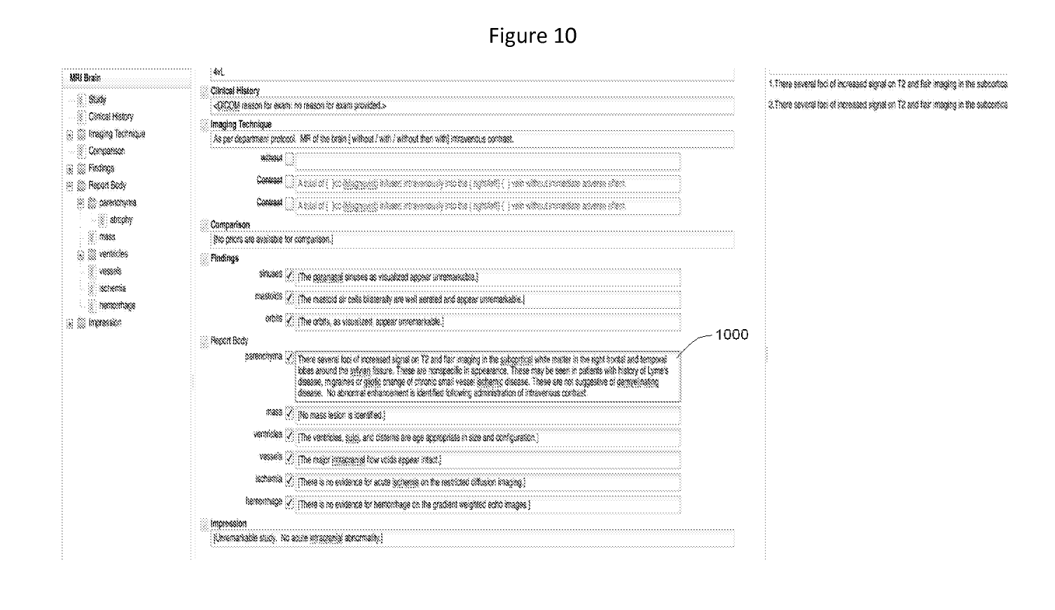

If the radiologist would like to change the default entry (highlighted text) in field 800 the radiologist may select the atrophy macro 808 from the menu on the left or alternatively, may select one of the history entries 804, 806 from the history list 802. As shown in FIG. 9, when the radiologist moves the mouse cursor over the history entries of the history list, the full text of the history entry is provided 900 so that the radiologist can read the full entry to determine if the entry is appropriate for the particular conditions observed in this patient. If the user clicks on the text, as shown in FIG. 10, the text from the history entry is populated to the field 1000 which had been selected by the radiologist (e.g. brain parenchyma field 800 of FIG. 8).

Thus, in this embodiment, when the radiologist selects a field of the report, the action of selecting the field causes the appropriate macros to be available via the menu and also causes a list of historical entries to be made available. If the radiologist selects one of the historical entries, the text of the historical entry is populated into the selected field of the report. In the illustrated example, the list of historical entries includes the first few words of the dictated entry. Optionally, the radiologist may label the entries to enable the entries to be more readily selected. For example, if the radiologist has dictated an entry for a particular type of rare condition, the radiologist may associate a label specifying the rare condition to the entry so that it is easier to find the entry associated with that rare condition at a later point in time.

It is important not only to create accurate and timely radiologic interpretations, but also to communicate those findings. In some instances, critical findings will require immediate action. In other instances, while interpreting images, radiologists may have feedback for the technologists who acquired the images or may wish to bring the studies to the attention of a consulting specialist. Accordingly, providing a way for radiologists to communicate is important to the radiologist, the other medical professionals with whom the radiologist is interacting, and ultimately to the patient.

In addition to health implications, communication of medical results has a legal Component—if an error is made and a lawsuit is instigated alleging medical malpractice, the ability to prove that a communication occurred and what was communicated can be extremely valuable.

Traditionally, if a radiologist came across a critical finding, the radiologist would look up the number of the referring physician, pick up the phone and dial the physician's office. If the radiologist thought a physician needed to be notified the radiologist might print out the report and fax it to the ordering physician's office. Later, perhaps days or perhaps years later in court, a question might arise as to whether the call was placed, what was communicated, and to whom. The physician might explain that the physician never received a telephone call, fax, email, or other communication.

According to an embodiment, while dictating a report a button labelled “communicate” is available for follow-up communication. The button may have other labels and the word “communicate” is merely one example of how the button may be labelled. Clicking on the button or other selecting the communication function available via the button results in a new inline frame <iframe> being opened, presenting multiple communication options.

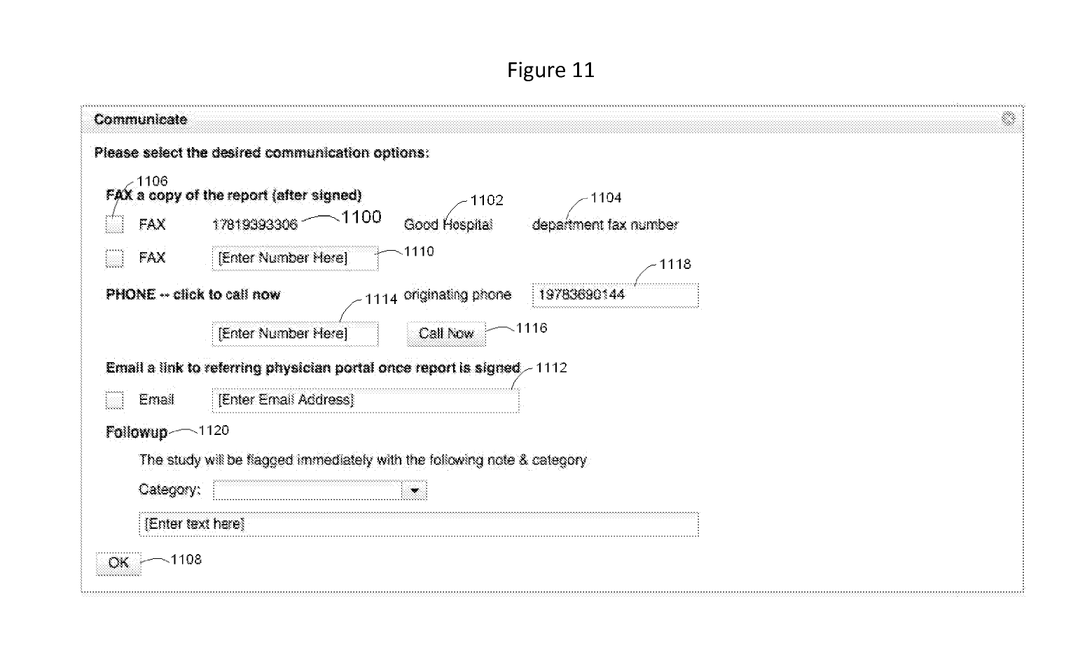

In one embodiment, a database stores contact information for the report, such as the requesting institution, department, and consulting, referring, and requesting physicians. When the communication button is selected, this information is used to populate communication frame such as the frame shown in FIG. 11. In FIG. 11, each of the pre-populated fax numbers associated with the report is presented along with a description (e.g. “home fax”). There are checkboxes next to each of the names and fax numbers so that the report, when completed can be faxed to those numbers. If the numbers are entered as default active in the database, the boxes are checked by default. There is also an empty box for entering a fax number not in the database.

FIG. 11 shows an example communication frame which may be presented to the radiologist when the communicate function is selected via the communicate button. As shown in FIG. 11, the frame includes one or more fax numbers 1100 where the report should be sent, along with a description of the institution 1102 and the department 1104 where the fax will be sent. If the user selects the check box 1106 and clicks on the OK button 1108, the report will be sent by facsimile to the intended recipient.

Although only one fax number has been included in the list of fax numbers, other fax numbers may be included as well. For example, if more than one physician needs to receive the report, multiple fax numbers may be included. The box 1106 may be pre-selected to indicate a default selection of where the report should be sent. A field 1110 is provided to allow the physician to enter a fax number for the report.

When the radiologist sends a fax, in one embodiment, the instructions from the radiologist are conveyed to the radiology server, which causes the radiology server to generate and send the fax. Accordingly, since the radiology server is sending the fax, the radiology server is able to log when the fax was sent, the recipient of the fax, whether the fax was reported as being received by the destination fax machine, and other information about the communication.

Similarly, the report may be electronically transmitted by email or other electronic messaging system. Similar to how fax numbers are pre-populated into the communication frame, email addresses and SMS contact information may also be pre-populated into the communication frame. In this embodiment, the contact information stored in the database also includes the email addresses for all institutions, departments and physicians connected to the study. Each email address is presented along with a description. There are checkboxes next to each of the names and address so that an email can be sent to those addresses notifying them of a report. If the addresses are entered as default active in the database, the boxes are checked by default. There is also an empty field 1112 for entering an email address not in the database. When the radiologist causes an email to be sent, the email is sent by an email server associated with the radiology server so that a log of the email may be associated with the report at the radiology server.

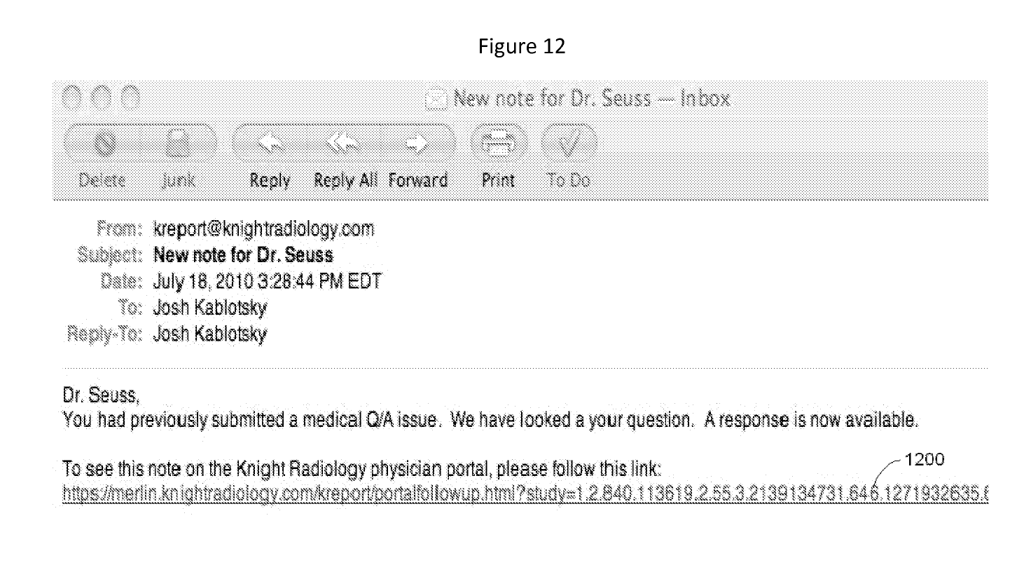

FIG. 12 shows an example email that may be delivered when a report is to be sent by email. As shown in FIG. 12, the email report contains an indication that the report is available, and a link 1200 to where the report may be located at the radiology server. By including a link to the report, rather than the report itself, the content of the report remains under the control of the server to minimize dissemination of private medical information via email. The radiology server can thus require a person to be authenticated prior to viewing the report, so that possession of the link, by itself, does not compromise the confidential information contained in the report or provide anyone with access to private medical information. Optionally, secure email may also be used to transmit the report. In this embodiment, rather than sending a link to the report, the report itself would be sent in an encrypted manner, e.g. using public key encryption.

Additionally, since the report remains under the control of the radiology server, the radiology server can log when other people access the report, so that a log may be maintained of who had access to the report and who actually accessed the report. In this manner the system is able to establish who received an email notification that the report was ready to be viewed and who actually viewed the report. Other statistics may be maintained as well, such as how long it took between notification and viewing, how long the report was viewed, etc.

Referring back to FIG. 11, the radiologist may also want to discuss the report with another physician, specialist, or other person. Accordingly, the communication frame includes a voice communication field 1114 in which the radiologist may type in a phone number. Optionally, this field may be associated with a telephone directory or other list of commonly called telephone numbers, of telephone numbers associated with the institution, department, referring physician, etc., or of other telephone numbers which the radiologist is likely to need. A call button 1116 may be selected to place the call.

Just as in the fax and email context discussed above, the phone numbers, with a brief description of the institution, department or physician associated with the telephone numbers, are displayed. Check boxes are also provided to allow the radiologist to select an intended person/number to call. The phone number of the reading radiologist (self) is also provided in Field 1118. When one of the other phone numbers is selected, and the radiologist selects the call button 1116, first the radiologist (self) number is called. After the radiologist answers, the other number (e.g. referring physician) is dialled and the two are connected. During the conversation, a dialog box may be presented for entering contemporaneous notes.

The radiology server thus handles establishment of the call between the radiologist and the radiology server, and then establishes a call between the radiology server and the physician. This causes the telephone based communication associated with review of the study to be passed through the radiology server, or to occur under the control of the radiology server, so that the radiology server is aware of the communication and is able to create a log of the communication. Optionally, the radiology server may also create a recording of the conversation to enable the content of the conversation to be associated with the study.

When the report is completed, signed and submitted, it is sent via HL7 to the hospital HIS/RIS. If the radiologist has indicated that the report should be faxed, or if there are default active fax destinations for that report, the report is submitted for faxing. The report is amended to note the date and time of fax attempt, the originator of the fax, and the intended recipient and fax number. When the fax attempt completes, whether successfully or otherwise, the report is further amended to note the result of the attempt. If the attempt is unsuccessful, the system administrator is notified.

When the report is completed, signed and sent, each checked email address is sent an email including a link (URL) to the report on the system's physician portal. In order to view the report the user must login using a unique username and password. Their login is recorded, along with the IP address from which the user is accessing the system. When the user views the report (or any other patient information or communication) it is noted in the audit record repository (ARR).

Another option in the communicate frame is to enter a follow-up note 1120. A follow-up note is a note attached to the study, made part of a permanent record but not part of the report, from an individual to an individual, a number of individuals, or a group. For example, the radiologist may wish to send a follow-up note to the technologist Quality Assurance (Q/A) group about the quality of images obtained. The sender of the note may designate that the recipients are to be notified by email of a new note. When the note is read on the system, it is tracked and logged.

Members of a follow-up group may be listed as to receive an email when a note is sent to that group. Some members may receive email while other members may not. Some groups also cause an auto-response. For example, if a referring physician sends a note to the medical Q/A group, the physician may receive an automated email from the Q/A group thanking the physician and notifying the physician about when to expect a response. Also for some groups, such as medical Q/A, if a user submits a follow-up-note then whenever there are subsequent notes that would be viewable by that user, the user is notified in email.

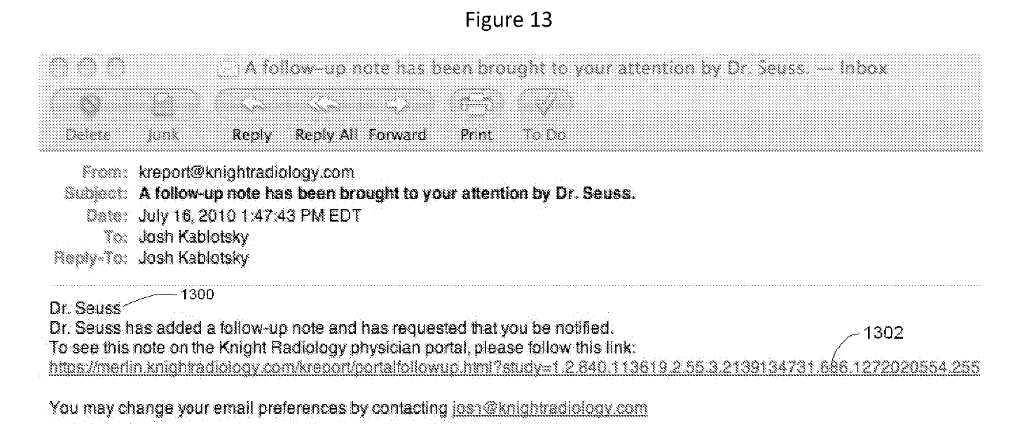

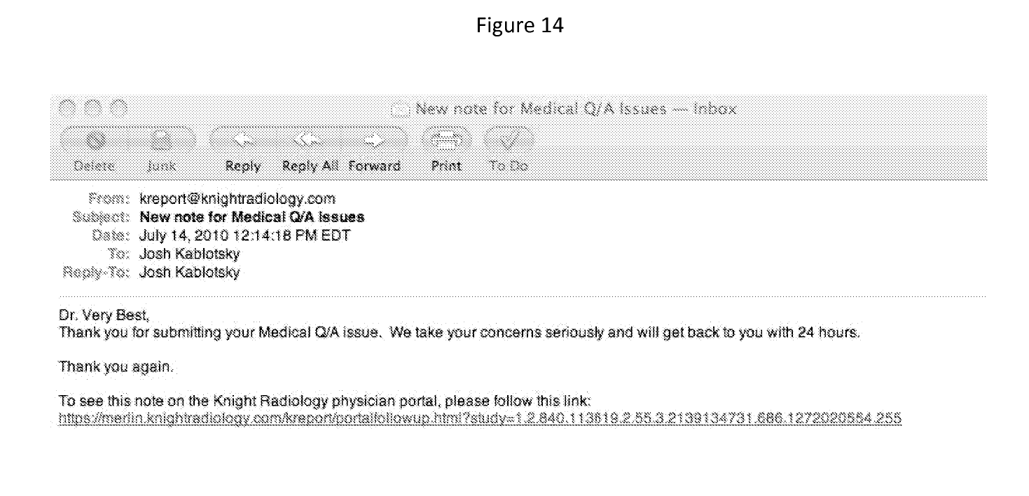

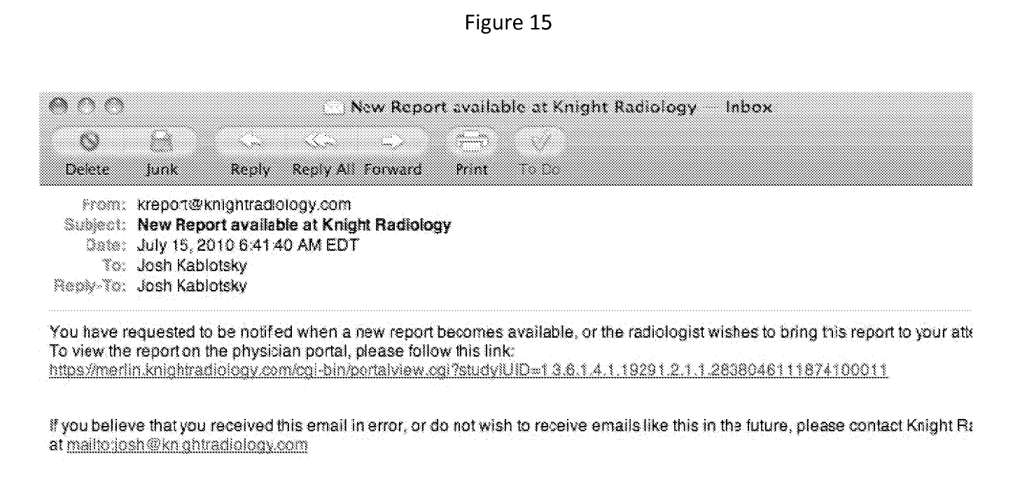

FIG. 13 shows an example follow-up note. As shown in FIG. 13, the follow-up note indicates which radiologist entered the follow-up note 1300 as well as a link 1302 to where the follow-up note may be found on the radiology server. If a recipient accesses the follow-up note, an entry to that effect is entered into the report. FIGS. 14 and 15 show additional email messages that may be generated as users review the follow-up note shown in FIG. 13 and generate additional responsive follow-up notes. The emails shown in FIGS. 13-15 allow the users to be notified that action is required in connection with a report. The users use the links in the email messages to access the follow-up notes associated with the report and to take action based on the follow-up reports. Since this activity is occurring at the radiology server, the radiology server is able to keep track of the activity associated with the follow-up notes to allow a complete log of all activity to be obtained and associated with the report.

Once the radiologist has finished a report, and has communicated the report to the intended recipient, the radiologist will need to generate a bill for the professional radiological services performed in connection with generating the report. Unfortunately, billing in the medical context is not a straightforward process. In the United States, there are several government programs which provide payment for radiological services, and numerous other private medical insurance plans which provide for payment of radiological services. Each of these payment mechanisms has its own billing rules. To standardize description of medical processes, several sets of codes have been established. These codes are used to allow everyone to communicate in a unified manner so that a given code is used by everyone to refer to a given procedure.

The typical process for radiological professional services billing is as follows: Someone in the hospital enters in an order for a radiology study. A radiology technologist obtains the images. A radiologist views the images and dictates a report. The report is entered into the hospital systems. The report is submitted to a billing company along with the billing code from the original order.

From this point, two types of problems often occur. One happens visibly, the other is invisible. Sometimes the images in the study are insufficient for the radiologist to satisfy that particular billing code. Sometimes the images may be sufficient, but the radiologist fails to note certain aspects of the study that are required for billing reimbursement. Coders at the billing company examine each report before asking the payer, usually an insurance company, for reimbursement. The coders look at the billing code used and then need to verify that every component of the report required for that billing code is present. If components of the report are not present, the report is sent back to the provider to be redone. The radiologist must then, often weeks later, re-interpret the study and dictate a new report—if that is even possible based on the imaging available.

The other problem that can occur is that the radiology technologist obtains images or performs a procedure, and the radiologist dictates a report with potentially greater billing value than the billing code submitted to the billing company. This potential revenue is never realized and the radiologist essentially has provided additional value for which the radiologist will not be compensated.

According to an embodiment, while using the reporting application to dictate a report, the radiologist makes choices about what template(s) to use, and which values to enter into which fields. Based on those choices, the correct billing code, or codes is/are selected. In the event that the text that the radiologist dictates does not justify the application of an intended billing code, the radiologist is warned to that effect before the physician is allowed to sign and send the report. The billing codes associated with the report may also be provided to the radiologist, along with an explanation of what the code represents.

The correct billing code(s) is converted to a unique, unambiguous human readable description, as given in the relevant American Medical Association (AMA) tables. The billing code(s), aka Current Procedural Terminology (CPT) or Healthcare Common Procedure Coding System (HCPCS) codes, are also added to the electronic version of the report filed with the hospital information system. The billing code(s) are placed in the electronic margins of each line such that it is clear which line(s) of the report justify which billing code(s). By adding the codes to the report, and notifying the radiologist when additional findings are required to satisfy a particular code, it is possible for the radiologist to ensure that all necessary findings are included in the report so that additional work is not required at a later date to enable the radiologist to be paid for analyzing a particular study.

The functions described above may be implemented as a set of program instructions that are stored in a computer readable memory and executed on one or more processors on the computer platform. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense.

What is claimed is:

1-60. (canceled)

61. A method of associating communications with a radiology report, the method comprising the steps of:
receiving a radiology report, by a radiology system, from a radiology workstation;
enabling communications associated with the radiology report to be initiated via the radiology system; and
logging communications associated with the radiology report.

62. The method of claim 61, wherein the step of enabling communications associated with the radiology report to be initiated comprises receiving a request, from the radiology workstation, for the radiology system to forward the radiology report via facsimile to a specified destination facsimile number.

63. The method of claim 62, further comprising the step of sending the radiology report, by the radiology system, to the specified destination facsimile number.

64. The method of claim 62, wherein the specified destination facsimile number is initially provided by the radiology system to the radiology workstation for selection via a radiology application used to generate the report.

65. The method of claim 61, wherein the step of enabling communications associated with the radiology report to be initiated comprises receiving a request, from the radiology workstation, for the radiology system to forward the radiology report via email to a specified destination email address.

66. The method of claim 65, further comprising the step of sending an email to the specified destination email address by the radiology system.

67. The method of claim 66, wherein the email contains an encrypted version of the report.

68. The method of claim 66, wherein the email contains a link to the report on the radiology system.

69. The method of claim 68, further comprising the steps of receiving, by the radiology system, a request for access to the report via the link, verifying authorization for access to the report, and logging the attempted access to the report via the link.

70. The method of claim 61, wherein the step of enabling communications associated with the radiology report to be initiated comprises receiving a request, from the radiology workstation, for the radiology system to forward the radiology report via text message to a specified number.

71. The method of claim 70, further comprising the step of sending a text message to the specified number by the radiology system.

72. The method of claim 70, wherein the text message contains a link to the report on the radiology system.

73. The method of claim 72, further comprising the steps of receiving, by the radiology system, a request for access to the report via the link, verifying authorization for access to the report, and logging the attempted access to the report via the link.

74. The method of claim 61, wherein the step of enabling communications associated with the radiology report to be initiated comprises receiving a request, from the radiology workstation, for a follow-up request to be sent by the radiology system to an intended recipient.

75. The method of claim 74, further comprising the steps of receiving a response from the intended recipient by the radiology system and passing the response from the radiology system to the radiology workstation.

76. The method of claim 61, wherein the step of logging communications associated with the radiology report comprises logging when the radiology report is transmitted from the radiology system to an intended recipient.
